(19) United States
(12) Patent Application Publication
(10) Pub. No.: US 2005/0061031 A1
(43) Pub. Date: Mar. 24, 2005

(54) Method of manufacturing glass melt, method of manufacturing molded glass materials, and method of manufacturing optical elements

(75) Inventors: Hidetsugu Kato, Tokyo (JP); Koji Suzuki, Tokyo (JP); Tsukasa Shimonishi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 10/913,473

(22) Filed: Aug. 9, 2004

(30) Foreign Application Priority Data
Aug. 8, 2003 (JP) 289489/2003

(51) Int. Cl. C03B 5/24

(52) U.S. Cl. 65/29.17; 65/29.18

(57) ABSTRACT

A method of manufacturing glass melt, a method of manufacturing molded glass materials from glass melt, and a method of manufacturing optical elements. In the method of manufacturing glass melt, glass is melted or glass melt is caused to flow out while monitoring the level of the glass melt in a vessel having a cover over the top thereof; a light beam for monitoring is directed approximately perpendicularly to the glass melt surface from the exterior of the vessel through an opening provided in the cover; and the light beam reflecting off the glass melt surface is caused to exit through the opening and is detected outside the vessel to monitor the level of the glass melt surface. The method of manufacturing a molded glass material comprises the steps of causing glass melt manufactured by the above method to flow out, and molding the glass that flows out. In the method of manufacturing an optical element, a precision press molding preform manufactured by the above method is heated and precision press molded.

### TECHNICAL FIELD

The present invention relates to a method of manufacturing glass melt, a method of manufacturing molded glass materials from glass melt, and a method of manufacturing optical elements.

### TECHNICAL BACKGROUND

In the course of feeding additional glass raw material into a vessel holding glass melt and causing molten glass to flow out of a vessel, it is necessary to monitor the level of glass melt accumulating in the vessel. FIG. 3 of Japanese Examined Patent Publication (KOKOKU) Showa No. 57-57413 (Reference 1) describes an example of a method of monitoring the glass melt level. In this method, light emitted by a laser beam projecting device mounted on one of the sidewalls of a refining vat reflects off the melt surface and is detected by an optical receiver mounted on the opposite sidewall of the refining vat to measure the glass melt level. This method is characterized in that the glass melt level is measured without contact.

However, since the laser beam projecting device and optical receiver are mounted on opposite sidewalls of the refining vat, the method disclosed in Reference I presents the following drawbacks.

Maintaining glass melt that is at elevated temperature within a prescribed temperature range is generally more difficult than maintaining glass melt that is at low temperature within a prescribed temperature range. The temperature of the refining vat also varies due to the inflow of newly molten glass and the outflow of glass that has been refined. Variation in the temperature of the refining vat causes it to deform, if only slightly, due to thermal expansion and thermal contraction. This deformation of the refining vat affects the positional precision of the laser beam projecting device and optical receiving device mounted on the sidewalls of the refining vat, thus affecting the results of measurement of the glass melt level and producing measurement error.

There is a further problem with the method disclosed in Reference 1 in that when the level of the glass melt surface varies significantly, the reflection position of the light emitted by the laser beam projecting device is displaced from the optical receiver, precluding measurement of the glass melt level.

The present invention, devised to solve these problems, has for its object to provide a method of manufacturing glass melt while accurately monitoring the level of the glass melt surface within the glass melt vessel, irrespective of the height of the glass melt surface, and a method of manufacturing molded glass materials from the glass melt manufactured by this method.

### SUMMARY OF THE INVENTION

(1) A method of manufacturing glass melt in which glass is melted or glass melt is caused to flow out while monitoring the level of the glass melt in a vessel having a cover over the top thereof,
characterized in that a light beam for monitoring is directed approximately perpendicularly to the glass melt surface from the exterior of the vessel through an opening provided in the cover, and the light beam reflecting off the glass melt surface is caused to exit through the opening and is detected outside the vessel to monitor the level of the glass melt surface.

(2) The method of manufacturing glass melt according to (1), wherein the vessel is a refining vat, and the top of the refining vat is tightly sealed except for the opening.

(3) The method of manufacturing glass melt according to (1), wherein the vessel is a glass melt surface monitoring vat connected to the refining vat so that the level of the glass melt level therein is identical to the level of the glass melt in the refining vat, and
in that the level of the glass melt in the glass melt surface monitoring vat is controlled so that the connection opening of the glass melt surface monitoring vat connecting to the refining vat is constantly kept below the surface of the glass melt, and so that the surface area of the glass melt within the glass melt monitoring vat is smaller than the maximum vertical cross-sectional area of the glass melt within the glass melt monitoring vat.

(4) The method of manufacturing glass melt according to any of (1) to (3), wherein the vessel is a refining vat or a glass melt surface monitoring vat positioned so that the level of the glass melt therein is identical to the level of the glass melt within the refining vat, and the amount of glass melt supplied to the refining vat from the melting vat where the glass is melted is controlled based on monitoring of the level of the glass melt surface.

(5) The method of manufacturing glass melt according to any of (1) to (4), wherein the light source emitting the light beam for monitoring and the optical receiver detecting the reflected light beam are both secured at a distance from the vessel.

(6) The method of manufacturing glass melt according to any of (1) to (5), wherein the amount of glass raw material supplied or the amount of glass melt flowing out is controlled based on monitoring of the level of the glass melt.

(7) A method of manufacturing a molded glass material comprising the steps of causing glass melt manufactured by any of the methods of (1) to (6) to flow out, and molding the glass that flows out.

(8) The method of manufacturing a molded glass material according to (7), wherein a prescribed weight of glass is separated from the glass flowing out, and the separated glass is molded into a precision press molding preform.

(9) A method of manufacturing an optical element comprising the step of mechanically processing a molded glass material obtained by the method according to (7) to manufacture an optical element.

(10) A method of manufacturing an optical element, characterized in that a precision press molding preform manufactured by the method according to (8) is heated and precision press molded.

### BRIEF DESCRIPTION OF THE DRAWINGS

FIG. 1 is a schematic cross-sectional view of the glass melting device employed in the present embodiment.

The present invention permits the manufacturing of glass melt while accurately monitoring the level of the glass melt surface within the melting vessel. As a result, the supply of glass raw material can be stabilized and the residence time of the glass in the steps of melting, refining, and homogenization can be made constant. This affords the advantages of permitting ready temperature adjustment in each step and obtaining glass of high quality.

Further, in the method of manufacturing a molded glass material by causing glass melt manufactured by the method of manufacturing glass melt of the present invention to flow out and molding the outflowing glass, keeping the surface level of the glass melt constant permits the maintaining of a constant difference in height (outflow head difference) from the surface of the glass melt to the tip of the outflow pipe and a constant glass temperature (viscosity), affording the advantages of stabilizing the glass outflow rate and yielding a molded glass material of highly precise shape.

### BEST MODE OF IMPLEMENTING THE INVENTION

(Method of Manufacturing Glass Melt)

The method of manufacturing glass melt of the present invention is one in which glass is melted or glass melt is caused to flow out while monitoring the level of the glass melt in a containing having a cover on top. The present invention is characterized in that a light beam for monitoring is directed approximately perpendicularly to the glass melt surface from the exterior of the vessel through an opening provided in the cover, and the light beam reflecting off the glass melt surface is caused to exit through the opening and is detected outside the vessel to monitor the level of the glass melt surface.

The level of the glass melt surface is monitored through the opening in the cover provided on the top of the vessel. When the glass melt comes into contact with air from the exterior, it reacts with water vapor or humidity in the atmosphere and is deformed slightly, or the properties of the glass shift from the desired values. Thus, a vessel having a cover on top is employed and a hole is provided in the cover so that a light beam for monitoring and a reflected light beam can pass through. For example, in optical glass, it is necessary to precisely set optical characteristics such as the index of refraction and dispersion. Thus, the opening is desirably made as small as possible without impeding the passage of the light beams. To strongly reduce modification of the glass melt and fluctuation in glass characteristics due to contact with external air, the opening is desirably made as small as possible to reduce contact between the glass melt and ambient air.

The light beam for monitoring is directed onto the surface of the glass melt through the opening, and the light beam reflecting the surface of the glass melt passes back through the opening and is picked up by the optical receiver. The light source emitting the light beam for monitoring and the optical receiver that detects the reflected light are both desirably secured away from the vessel to achieve precise monitoring. The securing of the light source and optical receiver away from the vessel permits monitoring of the level of, and any change in, the surface of the glass melt without the vessel being affected by expansion or contraction. Further, the light beam for monitoring is directed approximately vertically so that even when the level of the glass melt varies greatly, the position of the reflected light beam in the optical receiver does not shift greatly, permitting monitoring. This also permits a reduction in the size of the opening.

The light beam employed for monitoring is desirably a laser beam. The use of a laser beam permits a reduction in the diameter of the spot of the light beam and high brightness of the light beam. The monitoring method employed in the method of the present invention is not specifically limited; for example, the method of measuring phase difference may be employed.

Two laser beams are employed for the laser ranging sensor in the phase difference measurement method. One laser beam is employed for measurement and the other laser beam is employed for reference. The laser beam employed for measurement is emitted from a sensor head, reflects off the glass melt surface, which is the object being measured, and returns to the sensor, entering an optical receiving element within the sensor. Thus, when there is a change in distance between the sensor and the object being measured, the length of the optical path traveled by the laser beam employed for measurement changes. When a laser beam is directed perpendicularly to the surface of the glass melt and the change of the distance between the sensor and the glass melt surface is denoted as ΔL, the length of the optical path of the laser beam employed for measurement changes by 2 ΔL. The reference laser beam that is emitted by the light source is picked up by the optical element. The length of the path of the reference laser beam is fixed.

The measurement laser beam intensity and the reference laser beam intensity are intensity modulated at fixed amplitudes A, A′ and frequency f. For example, let the intensity of the measurement laser beam be:
I₁=A sin (2πft+φ)
and the intensity of the reference laser beam be:
I₂=A′ sin (2πft)
where φ corresponds to the phase difference between the two laser beams. Both laser beams are picked up by a single receiving element. The receiving element compares the optical intensities and outputs an electrical signal. Thus, the output signal of the optical receiving element denotes temporal change proportional to
A sin (2πft+φ)+A′ sin (2πft).
The change Δφ in the above phase difference can be expressed as 4πf·ΔL/c for the change in the optical path length 2 ΔL of the measurement laser beam (where c denotes the speed of light). Accordingly, it is possible to analyze Δφ from the output signal of the light receiving element and compute ΔL.

In actual measurement, the distance L serving as reference is measured in advance and the phase difference φ at that time is computed. A subsequent change in distance ΔL then appears as a change Δφ in phase difference, giving the actual distance L+ΔL.

The larger the modulation frequency f becomes, the larger Δφ becomes relative to ΔL, enhancing measurement precision. However, in the present invention, modulation frequency f desirably falls within a range of from 10² to 10³ MHz, preferably within a range of from 200 to 400 MHz, and more preferably within a range of from 300 to 450 MHz. This method permits measurement at a resolution of ±0.5 mm. The laser beam light sources are desirably both semiconductor lasers. Intensity modulation can be achieved by inputting a high-frequency signal oscillating at frequency f to the laser drive circuit to drive the semiconductor lasers. The optical receiving element must be able to handle frequencies substantially higher than modulation frequency f. From this perspective, the optical receiving element is desirably a PIN photodiode. The wavelengths of the measurement laser beam and reference laser beam desirably fall within a range of from 600 to 850 nm; different wavelengths are selected for the two laser beams.

In high-precision measurement, the modulation frequency is desirably stabilized, the laser output is desirably stabilized, and the intensity of the measurement laser beam and the intensity of the reference laser beam in the optical receiving element are desirably optimized.

It is possible to configure a circuit analyzing the phase difference change Δφ from the output signal of the optical receiving element in the form of a frequency conversion circuit converting the signal frequency to a low frequency with the phase difference remaining unchanged by a method called the beat-down method, and in the form of an analysis circuit based on known methods by combining automatic gain control amplifiers and phase comparison circuits to permit optimal processing even when the level of light received varies.

The distance between the laser ranging sensor and the surface of the glass melt desirably falls within a range of from 1 to 6 m, preferably a range of from 3 to 6 m, and more preferably a range of from 3 to 5 m. Small distances translate into high sensor temperatures and impede accurate measurement. Since the sensor is exposed to high temperature when separated from the glass melt by precisely the above-stated distance, the sensor head is desirably cooled, with a combination of water and air cooling being preferable. By contrast, an excessively great distance tends to impede accurate measurement due to external disruption.

In contrast to triangulation measurement methods, the method in which the laser beam strikes perpendicularly such as set forth above affords advantages in that the opening in the melt vessel can be made extremely small, as well as the following.

During production in which the glass melt level at a given time is denoted as a and then becomes b, in the triangulation measurement method, when a and b begin to differ substantially and the angles and positions of the sensors (both light emitting and light receiving elements) are not adjusted, the light does not correctly enter the optical receiving element. Further, the opening in the vessel must be enlarged so that the optical path is not impeded. However, in the method of the present invention employing approximately vertical light, this problem does not occur because the light constantly returns to the optical receiving element.

Further, since there are times when volatile gases escape continuously from the glass through the opening in the vessel, it is sometimes effective for accurate and stable glass melt monitoring to cause a gas to flow in the vicinity of the opening to blow off volatile gases in a manner that does not impede the laser beam.

Further, the glass melt emits intense light because it is at high temperature. Since the light (including infrared radiation and the like) given off by the glass enters the optical receiving element along with the monitoring laser beam, the light is desirably passed through a filter before entering the optical receiving element to eliminate the effects of light emitted by the glass.

The present invention is generally suited to optical glass manufacturing.

The above monitoring is desirably conducted at a position where the surface of the glass melt is horizontal. Thus, the monitoring is desirably conducted in the refining vat or in a glass melt surface monitoring vat provided for monitoring. Positions where bubbling of the glass melt is conducted and the vicinity thereof, as well as stirring positions and the vicinity thereof, are unsuited to monitoring.

When conducting monitoring in the refining vat, an opening is desirably provided in the top of the refining vat for the optical path of the light beam, and all portions other than this hole in the top of the refining vat are desirably tightly sealed.

The vessels employed are desirably divided into at least a melting vat for heating and melting the glass raw material, a refining vat, and a homogenization vat for stirring and homogenizing, with the vats being connected by pipes or the like. Further, the level of the glass melt in the various vats is desirably made identical. In this manner, it is possible to determine the level of the glass melt in each of the vats by monitoring just one location.

The level of the glass melt is desirably set so that the piping that connects the various vats and the connecting holes between the various vats are completely below the surface of the glass melt.

In particular, when the vessel in which monitoring is being conducted is a glass melt surface monitoring vat, the glass melt surface monitoring vat is suitably connected to the refining vat so that the level of the glass melt is identical to the level of the glass melt in the refining vat. Further, from the perspectives of reducing the area per unit of volume of the glass melt coming into contact with ambient air and suppressing the amount of volatization, the level of the glass melt in the glass melt surface monitoring vat is desirably controlled, so that the openings connecting the refining vat and the connected glass melt surface monitoring vat are constantly below the surface of the glass melt, and the surface area of the glass melt in the glass melt monitoring vat is smaller than the maximum vertical cross-sectional area of the glass melt in the glass melt surface monitoring vat.

The melting vat can be provided in the upper portion of the refining vat so that glass melted in the melting vat flows into the refining vat. When this is done, all the glass in the melting vat can be employed. This method is suitable when small quantities of glass are being melted and when using expensive glass raw materials. A mechanism controlling the amount of glass melt supplied to the refining vat can be positioned in the pipe delivering glass melt from the melting vat to the refining vat. Examples of such control mechanisms are pipe temperature adjusting devices that change the pipe temperature. Such adjustment devices vary the viscosity of the glass melt by raising and lowering the temperature of the glass melt in the pipe within a temperature range in which the glass does not devitrify, thus varying the flow rate of the glass in the pipe. For example, when increasing the supply rate, it suffices to increase the electrical current flowing to the heater of the adjustment device to heat the pipe and increase the flow rate of the glass. When decreasing the supply rate, it suffices to decrease the electrical current to lower the temperature of the pipe and diminish the flow rate of the glass.

The above described controlling of the supply rate of glass melt can be conducted based on the results of direct or indirect monitoring of the level of glass melt within the refining vat. When indirectly monitoring the level of glass melt in the refining vat, it is possible to monitor the level of the glass melt in a glass melt surface monitoring vat provided to have a glass melt level identical to that in the refining vat.

When the level of the glass melt in the refining vat decreases, the supply rate of glass melt to the refining vat can be increased, and when the level of glass melt in the refining vat increases, the supply rate of glass melt to the refining vat can be decreased through the operation of the above-mentioned control mechanism. Such control can be used to maintain the level of the glass melt in the refining vat within a certain range.

The refining vat, homogenization vat, connecting pipes, and pipes through which the glass melt flows out are desirably made of platinum or platinum alloy. The melting vat is desirably made of fire-resistant brick, platinum, or platinum alloy.

Controlling the supply rate of the glass raw material or the rate at which the glass melt flows out based on the surface level or change in surface level of the glass melt being monitored is desirable to stabilize glass characteristics and the rate at which the glass melt flows out.

(Method of Manufacturing Molded Glass Materials)

The method of manufacturing molded glass materials of the present invention is characterized by comprising the steps of causing a glass melt manufactured by the above-described method to flow out and molding the glass that flows out.

The glass melt is desirably caused to flow out of an outflow pipe, the temperature of which is controlled to prevent devitrification of the glass.

A number of examples of the molding of glass melt continuously flowing out at constant speed will be given.

In the first method, the outflowing glass melt is cast in a casting mold to mold sheet glass. The molded sheet glass is annealed and cut into pieces of prescribed weight to prepare a material for press molding known as “cut pieces.”

In the second method, a quantity of glass melt corresponding to the weight of a piece of targeted molded glass material is separated from the glass melt flow, molded into the desired shape while still soft, and cooled. The molded glass material can be reheated and press molded to manufacture optical elements such as lenses, prisms, and diffraction gratings. The surface of the molded glass material can also be processed by polishing prior to reheating and press molding. Glass material that has been press molded can also be processed by polishing to finish the optical element.

The second method is suited to the manufacturing of preforms for precision press molding. The term “precision press molding” refers to a press molding method in which heated glass is pressed in a pressing mold, the shape of the surface of the mold is transferred to the glass, and an optical element with an optically functional surface (a surface that optically functions to refract, diffract, pass, or reflect light) is obtained. In this method, it is unnecessary to finish the shape of the optically functional surface by mechanical finishing such as grinding or polishing. A precision press molding preform is a premolded glass material employed in precision press molding.

High weight precision is required in precision press molding preforms. When manufacturing precision press molding preforms by the second method, the quantity of glass flowing out is made constant to increase weight precision, the front end portion of the glass is separated in a regular period to separate glass of a certain weight, and the separated glass is molded to obtain preforms of constant weight. When the quantity of the glass flowing out in this state varies, the weight of the preform varies. However, since the level of the glass melt is kept constant in the second method, it is possible to maintain a constant vertical difference (outflow head difference) from the liquid surface to the tip of the outflow pipe through which the glass melt flows and a constant glass temperature (viscosity), thereby stabilizing the glass outflow rate (weight of glass flowing out per unit time). Accordingly, it is possible to manufacture preforms of high weight precision. Glass of a certain weight can be separated by the drip method as glass droplets from an outflow pipe and by a method in which the front end portion of the outflowing glass is supported, a constriction is formed part way along the outflowing glass flow, and the support is removed at a certain timing to separate the glass beyond the constriction. Since the glass is not cut by a cutting blade in these methods, shear markless preforms (free of cutting traces) can be molded.

The second method is suited to the manufacturing of preforms with a weight precision of ±2 percent or less, desirably ±1 percent or less, and preferably ±0.8 percent or less.

In the third method, glass melt corresponding to the weight of the targeted molded glass material is separated from the outflowing glass melt and the separated glass is press molded while still in a softened state. The press molded articles may also be suitably processed by grinding and polishing.

All of the above-described methods are suited to the manufacturing of optical elements.

A precision press molding preform manufactured by the second method can be heated and precision press molded in a pressing mold to manufacture optical elements. It is thus possible to mold various optical elements such as spherical lenses, aspherical lenses, microlenses, lens arrays, diffraction gratings, prisms with lenses, and lenses with diffraction gratings. The optical element obtained may also be subjected as needed to mechanical processing such as lens centering and edging around optically functional surfaces.

### Embodiments

### Embodiment 1

Embodiments will be described next with reference to the drawing.

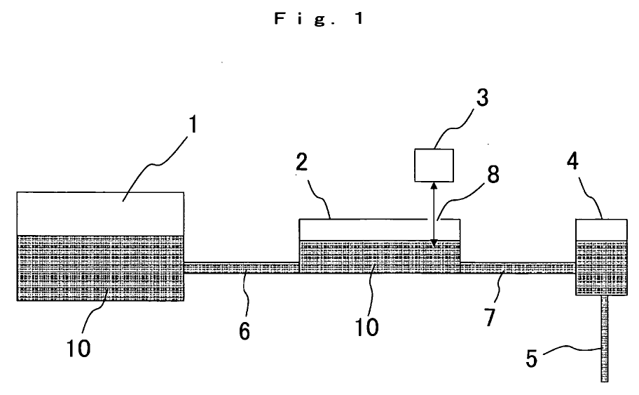

FIG. 1 is a schematic cross-sectional view of the glass melting device employed in the present embodiment. A raw material introduction opening, not shown, was provided in the top of a melting vat 1, through which glass raw material was introduced. The raw material that was introduced was heated and melted within the melting vat to obtain glass melt 10, which-flowed through a connecting pipe 6 to a refining vat 2.

An opening 8 was provided in the top of refining vat 2 to remove gas given off by the glass. A laser ranging sensor 3, equipped with a light source emitting a laser beam for monitoring the level of the glass melt and an optical receiving element receiving the laser beam reflecting off the glass melt surface, was secured above opening 8 away from refining vat 2.

The laser beam emitted by sensor 3 passed through opening 8, struck approximately perpendicularly the surface of glass melt 10 within refining vat 2, reflected off the surface, passed back through opening 8, and was picked up by the optical receiving element of sensor 3.

When the distance between sensor 3 and the glass melt surface changed, the point at which light was received by the optical receiving element shifted, and the amount of this shift was correlated with change in the level of the glass melt surface to monitor the level of the glass melt. Since sensor 3 was secured at a distance from refining vat 2, the effects of the expansion and contraction of the refining vat, pipes connecting the refining vat, and other vats were eliminated in the monitoring of the glass melt level.

Glass melt 10 that had been refined in refining vat 2 flowed through a connecting pipe 7 to homogenization vat 4, where it was stirred, and then flowed out through outflow pipe 5.

In the present embodiment, the level of the glass melt within the melting vat, refining vat, and homogenization vat was maintained identical. Accordingly, the level in the refining vat could be monitored to monitor the level in the various vats, or any change in that level.

Each of the above vats, connecting pipes, and the outflow pipe were comprised of a platinum alloy known as reinforced platinum and imparted heating and temperature adjustment functions.

The quantity of glass raw material introduced was controlled to maintain a constant glass melt level and glass outflow rate based on the results of the above monitoring.

Glass melt that flowed out was molded to obtain optical glass of constant refractive index and dispersion.

### Embodiment 2

Glass melt manufactured by the method of Embodiment 1 was caused to flow at a constant rate from an outflow pipe into a casting mold, and sheet glass comprised of optical glass containing rare earth element oxides was molded. The glass sheet was annealed and cut to the prescribed shape to manufacture cut pieces.

The cut pieces were then reheated and press molded in a pressing mold to obtain lens-shaped molded articles. The molded articles were processed by grinding and polishing to manufacture lenses. The optical characteristics of the lenses obtained exhibited the desired levels.

### Embodiment 3

Glass melt manufactured by the method of Embodiment 1 was supplied to the molding surface of a lower mold by causing it to flow out of an outflow pipe, and then pressed between the lower mold and an opposing upper mold to mold it into a lens shape. The molded product was subjected to grinding and polishing to manufacture lenses comprised of glass containing rare earth element oxides. The optical characteristics of the lenses obtained exhibited the desired levels.

### Embodiment 4

Glass melt was manufactured in a device different from that employed in Embodiment 1. The device was equipped with a melting vat for melting glass raw materials, a refining vat for refining glass melt, piping connected to the lower portion of the melting vat so that glass melt could flow from the melting vat into the refining vat, and an outflow pipe mounted to the lower portion of the refining vat (drawing omitted).

Cullet raw materials were employed as the glass raw material, with a required quantity of cullets being melted in the melting vat. Since the bottom of the melting vat was positioned higher than the refining vat, the glass melt flowed through a pipe into the refining vat. The glass melt was refined in the refining vat and flowed out of an outflow pipe.

The surface level of the glass melt within the refining vat was monitored by means of a laser beam entering and reflecting back through an opening provided in the top of the refining vat in the same manner as in Embodiment 1.

Further, a heater was wound around the pipe through which the glass melt flowed into the refining vat to control the temperature of the pipe. The power supplied to the heater was determined based on a monitoring signal of the glass melt surface level within the refining vat to control the flow rate of the glass melt within the pipe. When the level of the glass melt within the refining vat dropped below a reference level, the amount of power supplied to the heater was increased to raise the temperature of the glass within the pipe, decreasing the viscosity of the glass to increase the flow rate of the glass, thereby increasing the amount of glass supplied to the refining vat. Conversely, when the level of the glass within the refining vat exceeded a reference level, the amount of power supplied to the heater was decreased to diminish the flow rate of the glass within the pipe, increasing the viscosity of the glass to decrease the flow rate of the glass, thereby decreasing the amount of glass supplied to the refining vat. The level of the glass melt within the refining vat was thus kept constant. The level of the glass melt within the refining vat was directly monitored in the present invention. However, it is also possible to provide a glass melt surface monitoring vat connected to the refining vat so as to have the same level of glass melt and monitor the level of the glass melt within the monitoring vat.

In this manner, the height of the outflow head was maintained constant, droplets of glass of constant weight were dripped from the front end of the outflow pipe, these droplets were received in a preform pressing mold with upward blowing gas, and while floating the glass droplets by means of the wind pressure of the gas, spherical preforms for precision press molding were formed. By repeating the steps of dripping glass, receiving the glass droplets in a preform pressing mold, and forming the preforms while they were being floated, it was possible to mass produce preforms of constant weight. The weight precision of the preforms thus manufactured was ±1 percent or better.

Next, the front end of a glass melt flow flowing out of an outflow pipe was received by a support member, a constriction was formed part way along the glass flow, the support member was dropped at a prescribed timing to separate the glass below the constriction, the separated glass was received in the above-described preform pressing mold, and spherical preforms were formed while floating the separated glass. The various above-described steps were repeated to mass-produce preforms of constant weight. The weight precision of the preforms thus manufactured was ±1 percent or better.

Various preforms of highly precise weight for precision press molding were manufactured in this manner. Next, these preforms were heated and precision press molded in a pressing mold to manufacture aspherical lenses. This precision press molding was suitably conducted by known methods and under known conditions.

It is possible to manufacture various optical elements such as aspherical lenses, spherical lenses, microlenses, lens arrays, diffraction gratings, prisms, prisms with lenses, and lenses with diffraction gratings in this manner.

The present disclosure relates to the subject matter contained in Japanese Patent Application No. 2003-289489 filed on Aug. 8, 2003, which is expressly incorporated herein by reference in its entirety.

1. A method of manufacturing glass melt in which glass is melted or glass melt is caused to flow out while monitoring the level of the glass melt in a vessel having a cover over the top thereof, wherein a light beam for monitoring is directed approximately perpendicularly to the glass melt surface from the exterior of the vessel through an opening provided in the cover, and the light beam reflecting off the glass melt surface is caused to exit through the opening and is detected outside the vessel to monitor the level of the glass melt surface.

2. The method of manufacturing glass melt according to claim 1, wherein the vessel is a refining vat, and the top of the refining vat is tightly sealed except for the opening.

3. The method of manufacturing glass melt according to claim 1, wherein the vessel is a glass melt surface monitoring vat connected to the refining vat so that the level of the glass melt level therein is identical to the level of the glass melt in the refining vat; and the level of the glass melt in the glass melt surface monitoring vat is controlled so that the connection opening of the glass melt surface monitoring vat connecting to the refining vat is constantly kept below the surface of the glass melt, and so that the surface area of the glass melt within the glass melt monitoring vat is smaller than the maximum vertical cross-sectional area of the glass melt within the glass melt monitoring vat.

4. The method of manufacturing glass melt according to claim 1, wherein the vessel is a refining vat or a glass melt surface monitoring vat positioned so that the level of the glass melt therein is identical to the level of the glass melt within the refining vat, and the amount of glass melt supplied to the refining vat from the melting vat where the glass is melted is controlled based on monitoring of the level of the glass melt surface.

5. The method of manufacturing glass melt according to claim 2, wherein the vessel is a refining vat or a glass melt surface monitoring vat positioned so that the level of the glass melt therein is identical to the level of the glass melt within the refining vat, and the amount of glass melt supplied to the refining vat from the melting vat where the glass is melted is controlled based on monitoring of the level of the glass melt surface.

6. The method of manufacturing glass melt according to claim 3, wherein the vessel is a refining vat or a glass melt surface monitoring vat positioned so that the level of the glass melt therein is identical to the level of the glass melt within the refining vat, and the amount of glass melt supplied to the refining vat from the melting vat where the glass is melted is controlled based on monitoring of the level of the glass melt surface.

7. The method of manufacturing glass melt according to claim 1, wherein the light source emitting the light beam for monitoring and the optical receiver detecting the reflected light beam are both secured at a distance from the vessel.

8. The method of manufacturing glass melt according to claim 2, wherein the light source emitting the light beam for monitoring and the optical receiver detecting the reflected light beam are both secured at a distance from the vessel.

9. The method of manufacturing glass melt according to claim 3, wherein the light source emitting the light beam for monitoring and the optical receiver detecting the reflected light beam are both secured at a distance from the vessel.

10. The method of manufacturing glass melt according to claim 4, wherein the light source emitting the light beam for monitoring and the optical receiver detecting the reflected light beam are both secured at a distance from the vessel.

11. The method of manufacturing glass melt according to claim 1, wherein the amount of glass raw material supplied or the amount of glass melt flowing out is controlled based on monitoring of the level of the glass melt.

12. The method of manufacturing glass melt according to claim 2, wherein the amount of glass raw material supplied or the amount of glass melt flowing out is controlled based on monitoring of the level of the glass melt.

13. The method of manufacturing glass melt according to claim 3, wherein the amount of glass raw material supplied or the amount of glass melt flowing out is controlled based on monitoring of the level of the glass melt.

14. The method of manufacturing glass melt according to claim 4, wherein the amount of glass raw material supplied or the amount of glass melt flowing out is controlled based on monitoring of the level of the glass melt.

15. The method of manufacturing glass melt according to claim 7, wherein the amount of glass raw material supplied or the amount of glass melt flowing out is controlled based on monitoring of the level of the glass melt.

16. A method of manufacturing a molded glass material comprising the steps of causing glass melt manufactured by the method of claim 1 to flow out, and molding the glass that flows out.

17. The method of manufacturing a molded glass material according to claim 16, wherein a prescribed weight of glass is separated from the glass flowing out, and the separated glass is molded into a precision press molding preform.

18. A method of manufacturing an optical element comprising the step of mechanically processing a molded glass material obtained by the method according to claim 16 to manufacture an optical element.

19. A method of manufacturing an optical element, in which a precision press molding preform manufactured by the method according to claim 17 is heated and precision press molded.
